(19) United States
(12) Patent Application Publication
(10) Pub. No.: US 2024/0263657 A1
(43) Pub. Date: Aug. 8, 2024

(54) ADJUSTMENT ELEMENT WITH DAMPENING FASTENING SLEEVE AS WELL AS AN INSTALLATION METHOD AND A MANUFACTURING METHOD FOR SAME

(71) Applicant: BÖLLHOFF VERBINDUNGSTECHNIK GmbH, Bielefeld (DE)

(72) Inventor: Thorsten Rabe, Kalletal (DE)

(21) Appl. No.: 18/429,522

(22) Filed: Feb. 1, 2024

(30) Foreign Application Priority Data
Feb. 2, 2023 (DE) DE102023102634.8

(51) Int. Cl. F16B 5/02

(52) U.S. Cl. CPC F16B 5/0233

(57) ABSTRACT

An adjustment element with which a component is fastenable and positionable in the space has a sleeve-like hollow screw with a first and a second axial end, a drive feature and an outer thread at which the component is supportable and positionable in an axial direction of the hollow screw. The adjustment element also has a tube-like fastening opening that extends between the first and second axial ends of the hollow screw, a dampening fastening sleeve that is arranged within the fastening opening so that the hollow screw is fastenable by means of the fastening sleeve with a fastening means to a structural component and vibrations between the structural component and the hollow screw can be reduced.

### CROSS REFERENCE TO RELATED APPLICATIONS

This application claims the priority to German Patent Application No. DE102023102634.8 filed on Feb. 2, 2023, and the entire content of this priority application is incorporated herein by reference in its entirety.

### TECHNICAL FIELD

The present disclosure is related to an adjustment element with which a component is fastenable and positionable in the space. Furthermore, the present disclosure is related to an installation method with which an add-on part is fastenable to a structural component with the help of the adjustment element. Beside the fastening, the adjustment element also allows a positioning of the add-on part with respect to the structural component at the same time. Furthermore, the disclosure comprises a manufacturing method for the adjustment element.

### BACKGROUND

DE 10 2007 002 699 A1 describes a fastening assembly for a vehicle. This fastening assembly consists of a hollow screw with an outer thread which is fastened by means of a threaded bolt in a fastening opening of a structural component. As the inner diameter of the hollow screw is larger than an outer diameter of the fastening screw, this combination of fastening screw and hollow screw provides a lateral tolerance compensation. An adjustment part with inner thread is arranged on the outer thread of the hollow screw. By rotating the adjustment part, the axial position of the adjustment part on the hollow screw can be changed. In turn, an add-on part is connectable with the adjustment part so that a rotation of the adjustment part is possible, but no relative displacement between add-on part and adjustment part. Beside the plurality of the components of the fastening element, the combination of adjustment part, hollow screw and fastening screw requires a lot of space which is available in the vehicle to a limited extent, only.

DE 10 2016 207 868 A1 describes an assembly module for a vehicle light. This assembly module is also composed of a hollow screw with an outer thread. While the hollow screw is fastened to a structural component, a light is screwed on its outer thread. Depending on the screw-in depth of the hollow screw into the housing of the light, the axial position of the light with respect to the hollow screw can be adjusted. A fastening sleeve is arranged within the hollow screw by means of an axially firm rotation connection. This fastening sleeve provides a fastening opening or a fastening channel, which is run through by the shaft of a threaded bolt. The threaded bolt in turn serves for the fastening of the hollow screw to a structural component by means of the fastening sleeve. While the fastening sleeve is firmly screwed to the structural component, the axially firm rotation connection between the fastening sleeve and hollow screw guarantees a rotating of the hollow screw despite the fastening of the fastening sleeve to the structural component. This axially firm rotation connection between fastening sleeve and hollow screw is quite laborious as despite the movability of the hollow screw which needs to be provided, it needs to provide sufficient mechanical stability for fastening the vehicle light during the lifetime of the vehicle. Furthermore, the distance between the hollow screw and the structural component must be adjusted by means of the axially firm rotation connection so that the hollow screw is arranged in a rotatable manner without further ado. This necessary preciseness puts high requirements on the production of the assembly module compared to similar constructions from the state of the art.

WO 2019/110366 describes a similar fastening module for a vehicle light as DE 10 2016 207 868 A1 which was discussed above. Here, the light is also fastened by means of an outer thread of the hollow screw. The hollow screw in turn is fixed to a fastening opening of a structural component. For this purpose, the hollow screw has a punched disc at its axial end which faces the structural component. This punched disc has a central opening which can be run through by a threaded bolt. Furthermore, the punched disc is held at an axially firm position inside of the hollow screw in a circumferential groove. The combination of groove and punched disc allows a lateral displacement in order to compensate possible tolerances between the hollow screw and the fastening opening in the structural component. For fixing the threaded bolt which runs through the punched disc, a blind rivet nut is provided in a fastening opening of the structural component. The threaded bolt is screwed into these blind rivet nuts. The connection of punched disc and hollow screw provides an axially firm positioning of the hollow screw while being rotatable about its longitudinal axis at the same time. It is therefore possible to rotate the hollow screw so as to change an axial positioning of the light on the outer thread of the hollow screw.

A further adjustment element is disclosed by DE 20 2007 016 945 U1. This adjustment element fastens an add-on part in the space and at the same time, it provides a tolerance compensation in the three spatial directions x, y, z. For this purpose, the adjustment element comprises a hollow screw with an inner and an outer thread. A threaded sleeve is screwed into the hollow screw, which can be firmly screwed together with a structural component by means of a threaded bolt. As in terms of its inner diameter, the threaded sleeve is larger than the outer diameter of the fastening threaded bolt, the threaded sleeve guarantees a lateral tolerance compensation in combination with the outer hollow screw. In addition to that, the hollow screw which is arranged on the threaded sleeve may be displaced axially by means of rotation in order to change an axial position of a fastening add-on part. This adjustment element does not provide a large variability with regard to the adjustment possibilities in all three spatial directions, it is, however laborious in terms of the production due to the number of individual parts.

Another configuration of an adjustment element is described in DE 10 2022 115 126 A1. This adjustment element fastens for example an add-on part to a structural component. For this purpose, a hollow screw is screwed into an add-on part which is held inside by means of an assembly sleeve. Due to the axial and radial dimensioning of the assembly sleeve, a rotating of the hollow screw is possible despite the fastening of the hollow screw to the structural component. As the assembly sleeve is larger in terms of its inner diameter than an outer diameter of a threaded bolt extending through same, a lateral tolerance compensation of the hollow screw is guaranteed.

It is an object of at least some implementations of the present disclosure to provide an alternative and structurally simple adjustment element which guarantees a reliable installation of an add-on part to a structural component.

### SUMMARY

The above object is solved by an adjustment element, a structural component in combination with the adjustment element, by an installation method of an add-on part to a structural component with the help of the adjustment element as well as by an injection-molding method for manufacturing the adjustment element. Advantageous embodiments and further developments of the present disclosure are derived from the following description, the drawings as well as the appending claims.

With the adjustment element, a component is fastenable and positionable in the space. Positionable means that in the fastened state of the adjustment element, the component is displaceable on a hollow screw in axial direction of the adjustment element by rotating the hollow screw. In the same way, the hollow screw and component, which may be an add-on part, be displaced relatively with respect to one another, before the adjustment element is fastened to a further component, e.g. a structural component. By that, a distance between component and structural component is changed or pre-set. The adjustment element comprises the following features: a sleeve-like hollow screw with a first and a second axial end, a drive feature and an outer thread at which a component is retainable and positionable in axial direction of the hollow screw, a tube-like fastening opening extends between the first and the second axial end of the sleeve-like hollow screw, a dampening fastening sleeve is arranged within the tube-like fastening opening so that the hollow screw is fastenable by means of the fastening sleeve with a fastening means to a component and vibrations between the component and the hollow screw and reducible.

The adjustment element is made of the sleeve-like hollow screw. Same comprises an outer thread on its outer side, which is fastenable in a component, e.g. an add-on part such as a vehicle light or a handle construction, by being screwed into a corresponding opening. For this purpose, a self-grooving or self-inhibiting thread is for example suitable as the outer thread. Other kinds of threads may be used which guarantee a reliable retention between the hollow screw and the add-on part.

The outer thread which extends along the longitudinal axis of the hollow screw on the outside guarantees, by means of the rotating of the hollow screw, that the add-on part is positionable in axial direction of the hollow screw or the adjustment element, respectively. Even after the installation or fastening of the adjustment element to a structural component, e.g. a vehicle body, the kind of fastening of the hollow screw may also guarantee a rotating of the hollow screw around its longitudinal axis. At the same time, the position of the hollow screw is determined, so that there is only an axial degree of freedom for the rotation of the hollow screw.

This function of the adjustment element may be realized by means of a fastening sleeve which is arranged centrally in the adjustment element. For this purpose, the fastening sleeve may support itself axially on one side outside of the hollow screw. Toward the axial support of the fastening sleeve to the hollow screw, the hollow screw and the fastening sleeve may be fastened by means of a fastening means, which may be a threaded bolt, to a structural component or generally to a further component. For this purpose, the fastening means passes through a continuous fastening opening of the fastening sleeve. The threaded bolt is also screwed into or fastened in a thread opening of the structural component, here, which may be the vehicle body. A blind rivet, a locking bolt or the like may be used as the fastening means, which are held in a fastening opening of the structural component.

The inner side of the hollow screw may contact the shell-like outside of the fastening sleeve. Possible vibrations of the structural component are transmitted firstly on the fastening sleeve due to the fastening of the fastening sleeve to the structural component, and from there to the hollow screw and the add-on part connected to it. The possible vibration transmission is also conceivable in opposite direction. In order to reduce or avoid the vibration transmission in both directions, the fastening sleeve may be configured so that it dampens vibrations. Accordingly, a layer of elastic or of elastic-plastic material or of plastic material may be provided on the contacting and boundary surface between fastening sleeve and hollow screw, which can absorb or dampen arising vibrations.

According to an embodiment of the adjustment element, its dampening fastening sleeve comprises a circumferential and outwardly protruding radial collar on a first axial end, which may project beyond an inner diameter of the tube-like fastening opening, so that the fastening sleeve can be axially supported on the first or the second axial end of the hollow screw.

The function of the adjustment element is mainly based on the combination of the sleeve-like hollow screw and the dampening fastening sleeve. The dampening fastening sleeve has a T shape in its cross section so that when it is plugged into the tube-like fastening opening of the hollow screw, it rests against one of the axial ends of the hollow screw, as the outwardly projecting radial collar of the fastening sleeve is configured larger in terms of its diameter than an inner diameter of the fastening opening of the hollow screw. This guarantees that the fastening sleeve cannot be received completely by the fastening opening within the hollow screw. Rather, the supporting radial collar of the fastening sleeve generates a form-fit connection taking effect in axial direction of the hollow screw. Due to the use of the centrally arranged fastening sleeve, it may be possible to fasten the adjustment element to a structural component via the fastening sleeve, because as soon as the fastening sleeve is fastened to a structural component by means of a fastening means, the hollow screw is also held in this position at the structural component.

The dampening fastening sleeve without radial collar may be configured longer when measured in axial direction than the tube-like fastening opening, so that the hollow screw is rotatably fastenable to a structural component at the fastening sleeve.

According to the above-described further constructive configuration of the fastening sleeve, same may be configured longer in terms of its axial length starting at the underside of the radial collar than the tube-like fastening opening of the hollow screw. In other words, the radial collar abuts an axial end of the hollow screw while the axial end opposite the radial collar of the fastening sleeve projects from the tube-like fastening opening of the hollow screw. If based on this geometric configuration, the adjustment element is fastened to a structural component with the help of the fastening means, a block connection of the fastening sleeve with the structural component still guarantees a rotation of the hollow screw on the dampening fastening sleeve.

In a further embodiment, the dampening fastening sleeve comprises a first elastic dampening layer on a radially outer lateral surface so as to reduce a vibration transmission between the hollow screw and the fastening sleeve.

Due to the arrangement of the fastening sleeve within the tube-like fastening opening of the hollow screw, a contact surface between these two components may be formed. A radially outer lateral surface of the fastening sleeve may abut a circumferential inner limiting wall of the tube-like fastening opening of the hollow screw. In a compound of an add-on part with a structural component based on the effect of the adjustment element, it is often the case in practice that vibrations of the add-on part or the structural component arise and are transmitted on the respective other part. It is also possible that both the structural component as well as the add-on part are subject to vibrations, each transmitting on the respective other part. Most of the time, such vibrations have a negative effect on the established connection, the lifetime of the add-on part but also the lifetime of the structural component or a connection with the structural component. It is therefore desirable that a transmission of vibrations between the add-on part and the structural component are avoided to the greatest possible extent.

For this purpose, the present connection may use a dampening layer which is applied on the outer lateral surface of the fastening sleeve, specifically may be on the shaft of the fastening sleeve. Due to the construction of fastening sleeve and tube-like fastening opening of the hollow screw, this elastic dampening layer may be arranged in a portion where the fastening sleeve abuts or contacts the inner wall of the fastening opening of the hollow screw. Due to this arrangement, vibrations, which are transmitted by the hollow screw and/or the fastening sleeve, are dampened by a deforming of the dampening layer.

An inner diameter of the tube-like fastening opening may be smaller than an outer diameter of the dampening fastening sleeve with elastic dampening layer, so that the fastening sleeve is held in a friction-fit manner in the tube-like fastening opening.

For supporting the dampening effect of the dampening layer on the fastening sleeve, the inner diameter of the tube-like fastening opening may be configured slightly smaller than the outer diameter of the dampening fastening sleeve. This may guarantee a press-fit of the fastening sleeve within the fastening opening. While the friction-fit which is generated by that between the fastening sleeve and the hollow screw supports the compound of the adjustment element, an effective transmission of possible vibrations into the dampening layer is also ensured.

According to a further embodiment, the radial collar comprises a second elastic dampening layer on a side facing the fastening sleeve so as to reduce a vibration transmission in axial direction between the hollow screw and the fastening sleeve.

As has already been described above, the first elastic dampening layer may be arranged on the radial outer lateral surface of the fastening sleeve. Due to this arrangement, the dampening or reduction, respectively, of vibrations in radial direction of the fastening sleeve and/or the hollow screw may be supported. Due to the press-fit of the fastening sleeve within the tube-like fastening opening, vibrations may be reduced in an angled alignment with respect to the radius of the fastening sleeve.

As it is also conceivable that in practice, vibrations arise in axial direction of the fastening sleeve and/or the hollow screw, a second dampening layer is arranged on that side of the radial collar which faces the shaft of the fastening sleeve. This second dampening layer may rest against the one axial end of the hollow screw in axial direction when the adjustment element is fastened with the help of the fastening means to the structural component. Vibrations in axial direction of the adjustment element are reduced or dampened by that.

In this context, the first and the second dampening layer may be provided as a joint dampening layer on the radial outside of the fastening sleeve and the bottom side of the radial collar which faces the shaft.

The adjustment element may be fastenable by means of the fastening means to a structural component, the outer diameter of which is smaller than an inner diameter of the fastening sleeve so as to guarantee a radial tolerance compensation between the adjustment element and the fastening means.

Once the dampening fastening sleeve has been fastened to the structural component by means of the fastening means, the sleeve-like hollow screw may be rotated in order to displace the add-on part fastened to it in axial direction of the hollow screw. At the same time, the above-described dimensioning of the outer diameter of the fastening means and of the inner diameter of the fastening sleeve allows that the fastening sleeve can be displaced in radial direction with respect to the fastening means. Due to this radial displaceability, the combination of fastening means and fastening sleeve guarantees a tolerance compensation perpendicular with respect to the longitudinal axis of the adjustment element. Due to the combination of the above-mentioned possibilities of compensating tolerances, the add-on part can be arranged freely with a certain flexibility in the space.

Furthermore, the present disclosure includes a structural component with a fastening opening to which the adjustment element according to one of the above-described embodiments is fastened with a fastening means.

Provided that a first component or the above-mentioned add-on part means a handle construction of a vehicle door or a vehicle light or the like, the structural component may be formed by the vehicle body or another supporting part on a vehicle. In the same way, it is also conceivable that a structural component generally refers to a carrying part to which another component is fastened with the help of the adjustment element. Such component combinations are not limited to vehicle construction but relate to all possible areas in construction and life.

A component may be fastened on the outer thread of the hollow screw of the adjustment element in a way that tolerances between the structural component and the component can be adjusted.

The present disclosure furthermore comprises an installation method with which an add-on part, which may be a light, is fastenable and positionable at a structural component, which may be a vehicle body. The installation method comprises the following steps: screwing-in a hollow screw of the adjustment element according to one of the above configurations into a supporting opening of the add-on part, rotating the hollow screw which is fastened to the structural component such that the add-on part is displaced along a longitudinal axis of the hollow screw and fastening the hollow screw with add-on part to a fastening opening of the structural component with a fastening means which is arranged within the tube-like fastening opening of the dampening fastening sleeve.

The installation method is based on the space-saving and economic construction of the above-described adjustment element. Accordingly, it is produced with low effort and subsequently also installed. In a first step, the hollow screw of the adjustment element may be screwed into a supporting opening of the add-on part, which may be a handle construction. Subsequently, the hollow screw is fastened in a thread opening of the structural component, which may be the vehicle body, with the help of a threaded bolt. According to various embodiments of the present disclosure, the thread opening may consist of a bore hole with inner thread, of a blind rivet nut which is fastened in a bore hole or of a welding nut which is arranged adjacent to an opening. Due to the threaded connection of the hollow screw with the structural component with the help of the threaded bolt, the positioning of the add-on part with respect to the structural component is determined. In this fastening between add-on part and structural component, only the hollow screw has the degree of freedom to rotate. This degree of freedom may be used with the help of a tool in order to set a distance between the structural component and in the add-on part. Accordingly, a tool engages into the hollow screw or to the hollow screw and rotates same around its longitudinal axis. In this way, the add-on part which is fastened on the outer thread of the hollow screw is displaced along the longitudinal axis of the hollow screw until the suitable distance between structural component and add-on part has been reached.

For the further configuration of the installation method, it comprises the further step: providing the fastening opening of the structural component with a thread, which may be by means of a welding nut or a blind rive nut, the thread being configured so as to match a threaded bolt as the fastening means.

According to a further embodiment of the installation method, the further step is provided: arranging the threaded bolt in combination with a supporting disc in the dampening fastening sleeve, so that the hollow screw may be fastened in a rotatable manner on the structural component.

In addition, a rotating of the hollow screw may take place by means of an outer or an inner drive feature during the installation method so as to change the axial position of the add-on part on the hollow screw.

In order to displace the add-on part and the hollow screw relative with respect to one another, the hollow screw may include a drive feature which can be arranged on the radial outside but also radially inside the hollow screw. As a radially outer or a radially inner drive feature, each form-fit connection is suitable, as for example a polygonal form or a slit form which guarantees the engagement of a suitable tool.

Furthermore, the present disclosure includes an injection molding method with which an adjustment element according to one of the above-mentioned configurations can be produced and which comprises the following steps: providing an injection mold having the complementary form features regarding the adjustment element, injection molding the hollow screw and the fastening sleeve with a first plastic material in a first injection and injection molding a dampening layer on an outer surface of the fastening sleeve with a second plastic material in a second injection, with the second plastic material having a higher elasticity or plasticity than the first plastic material.

A 2-K-injection molding method (2-K=two components) is generally known in the state of the art. Here, it is used for injection-molding the hollow screw and the fastening sleeve arranged on it with a first plastic material in a first step. This first plastic material is characterized by a sufficient stability in order to retain the hollow screw for example in an add-on part by means of a suitable, e.g. a self-inhibiting threaded connection. According to the above description, the fastening sleeve serves for the fastening of the add-on part to a structural component by means of the adjustment element. Accordingly, the plastic material of the fastening sleeve therefore needs to comprise sufficient stability for such a fastening.

In a second injection, a dampening plastic material is injected into the injection mold in order to produce a dampening plastic layer on the fastening sleeve. As a dampening plastic layer, an elastomer is for example suitable, which yields elastically under a mechanical load, thereby dampening or reducing arising vibrations.

In this context, a plastically deformable plastic material may be processed as the dampening layer in the second injection in the injection molding method. The dampening layer may fill a gap present between the fastening sleeve and the adjoining inner wall of the tube-like fastening opening. When mechanical loads arise between the fastening sleeve and the hollow screw, the plastically deformable plastic material deforms, which leads to a reduction of arising vibrations between the two parts of the connection.

According to a further embodiment of the injection molding method, the injection molding of the dampening layer takes place on an outer lateral surface of the fastening sleeve or on the outer lateral surface and a side of the radial collar of the fastening sleeve which faces the lateral surface.

### BRIEF DESCRIPTION OF THE DRAWINGS

In the following, the present disclosure will be described in detail with reference to the drawings. In the drawings, the same reference signs denote the same components and/or elements. They show:

FIG. 1 a perspective view of an embodiment of the adjustment element consisting of a sleeve-like hollow screw and a dampening fastening sleeve arranged in the tube-like fastening opening without a fastening means,

FIG. 2 a perspective view of an exploded view of the hollow screw with fastening sleeve of FIG. 1 in which the fastening sleeve comprises a dampening layer only on a radial outer wall of a shaft of the fastening sleeve over partial surfaces,

FIG. 3 hollow screw and fastening sleeve of FIG. 2 during the assembly,

FIG. 4 a perspective lateral view of a further embodiment of the hollow screw with fastening sleeve in which a radial collar of the fastening sleeve includes a dampening layer on a side facing the hollow screw,

FIG. 5 a perspective lateral view of a further embodiment of the adjustment element with hollow screw and fastening sleeve, in which a dampening layer between the radial collar of the fastening sleeve and the hollow screw includes an injection attachment from a 2K injection molding method within the radial collar,

FIG. 6 a perspective view of a fastening sleeve with continuous fastening layer,

FIG. 7 a perspective view of a further embodiment of the adjustment element consisting of the hollow screw and the fastening sleeve with outer dampening layer according to FIG. 6,

FIG. 8 a lateral sectional view of an embodiment of the adjustment element with hollow screw and fastening sleeve as shown in FIG. 5,

FIG. 9 a lateral sectional view of an embodiment of the adjustment element having an add-on part and being arranged on a structural component,

FIG. 10 a lateral sectional view of an embodiment of the adjustment element with an add-on part being fastened to the hollow screw as well as a fastening to a structural component with the help of a fastening means in which the fastening sleeve is configured longer than the hollow screw,

FIG. 11 a lateral sectional view of an embodiment of the adjustment element with an add-on part being fastened to the hollow screw as well as a fastening to a structural component with the help of a fastening means in which the fastening sleeve ends adjacent to the structural component together with the hollow screw,

FIG. 12 a flow chart of an embodiment of an installation method, and

FIG. 13 a flow chart of an embodiment of a manufacturing method of the adjustment element.

### DETAILED DESCRIPTION

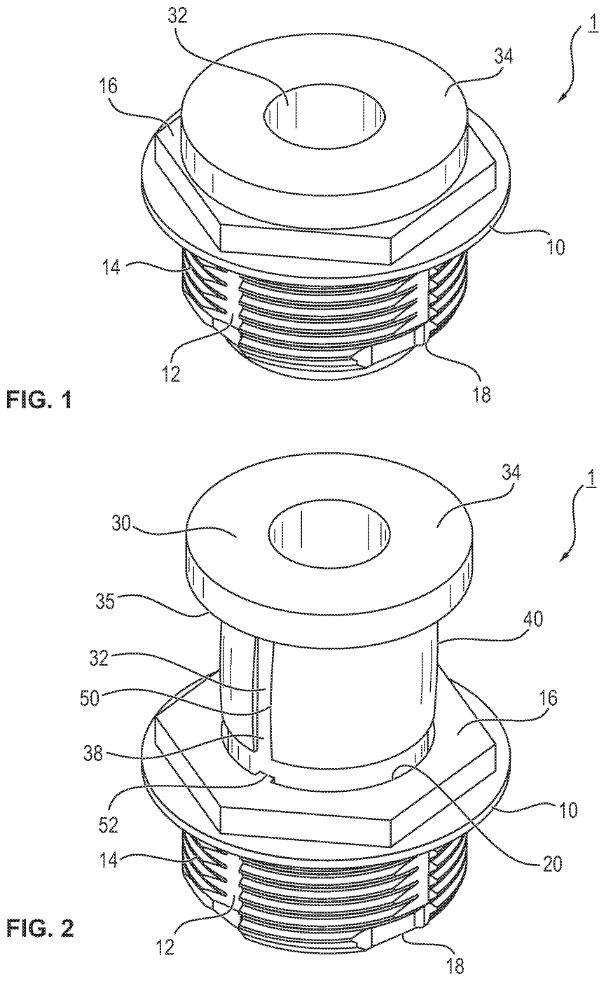

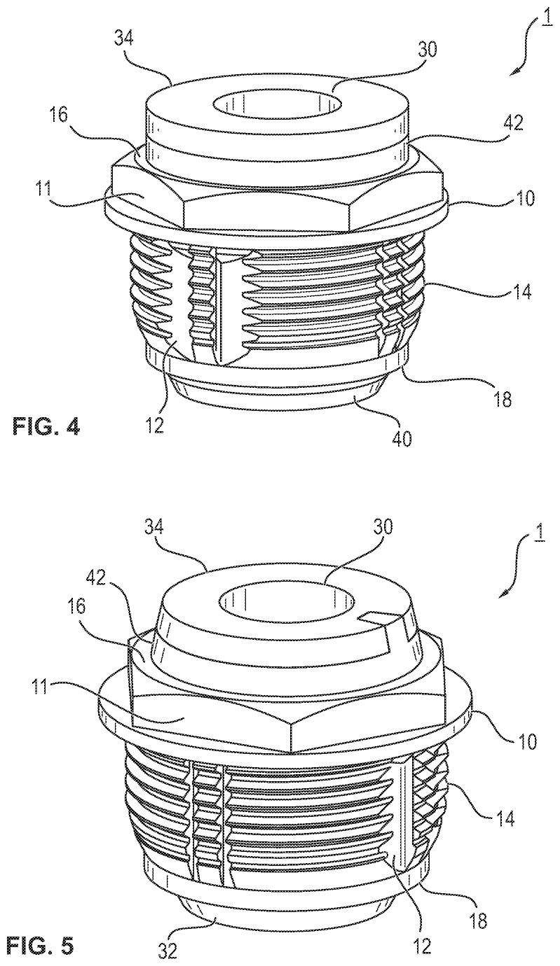

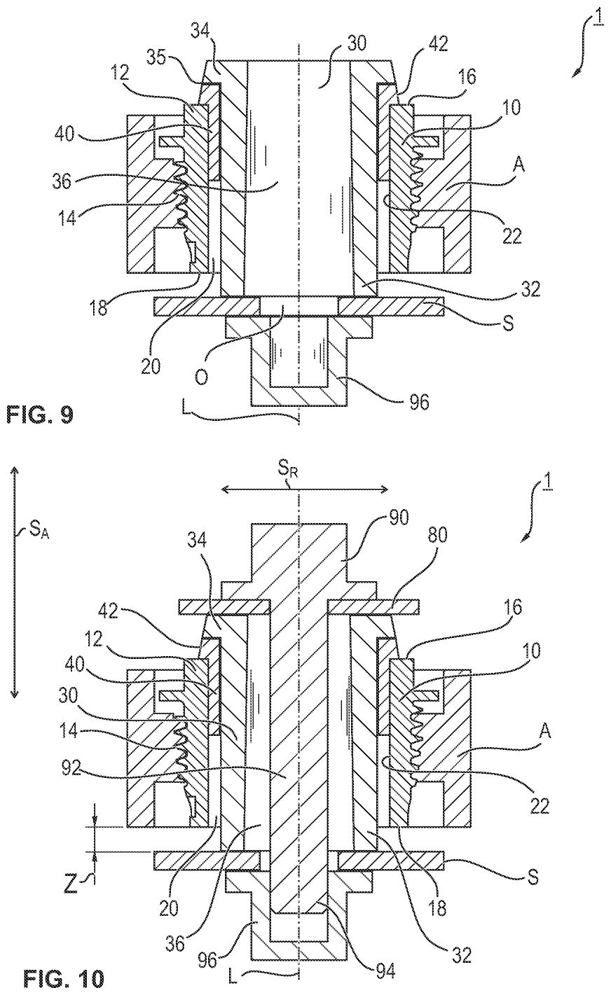

FIG. 10 shows an embodiment of a connection of a structural component S, which may be a vehicle body, with a component or add-on part A, which may be a door handle or a vehicle light. The structural component S and the add-on part A are connected with each other by means of an adjustment element 1, which can be recognized in a further embodiment in FIG. 10 in a sectional view. Further embodiments of individual components of the adjustment element 1 may be gathered from FIGS. 1 to 11.

The structural component S has a fastening opening O. According to a further embodiment, the fastening opening O may be provided in combination with a nut thread element such as a welding nut or a blind rivet nut C with inner thread (not shown) or by an integrally configured thread directly in the fastening opening O in the structural component S.

The structural component may be provided with a threadless opening. The adjustment element 1 can be fastened to this opening with a blind rivet nut, a plug connection, a bayonet connection, a locking pin and the like.

Hereinafter, a threaded bolt 90 is described as an example for a fastening means.

The adjustment element 1 according to FIG. 10 may be comprised of a sleeve-like hollow screw 10. The sleeve-like hollow screw 10 is formed like a hollow cylinder with a circumferential wall 12. The circumferential wall 12 has an outer thread 14 on a radial outside. With the outer thread 14, the hollow screw 10 and thus the adjustment element 1 may be screwed together with the add-on part A. The hollow screw 10 may be rotated by means of an outer drive feature 11, which may be a polygon or hexagon.

The outer thread 14 may have a self-inhibiting configuration. The hollow screw 10 can thus be rotated in an opening of the add-on part A and be axially displaced by that, without the thread connection between the hollow screw 10 and the add-on part A to release.

The threaded connection between the hollow screw 10 and the add-on part A has the advantage that a rotating of the hollow screw 10 around its longitudinal axis L displaces the add-on part A relatively with respect to the hollow screw 10 in the direction of the longitudinal axis L of the hollow screw 10. In this way, a distance Z between the add-on part A and the structural component S can be changed and adjusted, as is shown in FIG. 8.

For this purpose, the hollow screw 10 may be fastened in a rotatable manner around its longitudinal axis L to the structural component S. The fastening is explained in more detail below.

A tube-like fastening opening 20 extends between a first 16 and a second axial end 18 of the hollow screw 10 inside same. The tube-like fastening opening 20 may have a constant inner diameter which is determined by a circumferentially extending limiting wall 22. The limiting wall 22 may be configured smooth in order to serve as a supporting surface (see below).

A dampening, which may be a vibration dampening fastening sleeve 30 is arranged in the tube-like fastening opening 20. This fastening sleeve 30 includes a shaft 32 from a first axial end of which a radial collar 34 extends to the radial outside. The radial collar 34 may encompass the shaft 32 in a continuously circumferential manner. The radial collar 34 has an outer diameter which is larger than an inner diameter of the tube-like fastening opening 20. An outer diameter of the shaft 32 is smaller than the inner diameter of the tube-like fastening opening 20. Based on this configuration of the fastening sleeve 30, the shaft 32 of same may be received in the tube-like fastening opening 20, while the radial collar 34 rests against the first axial end 16 of the hollow screw 10.

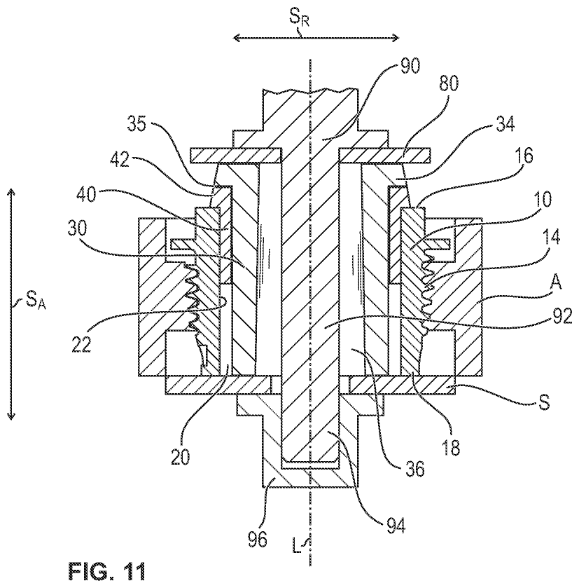

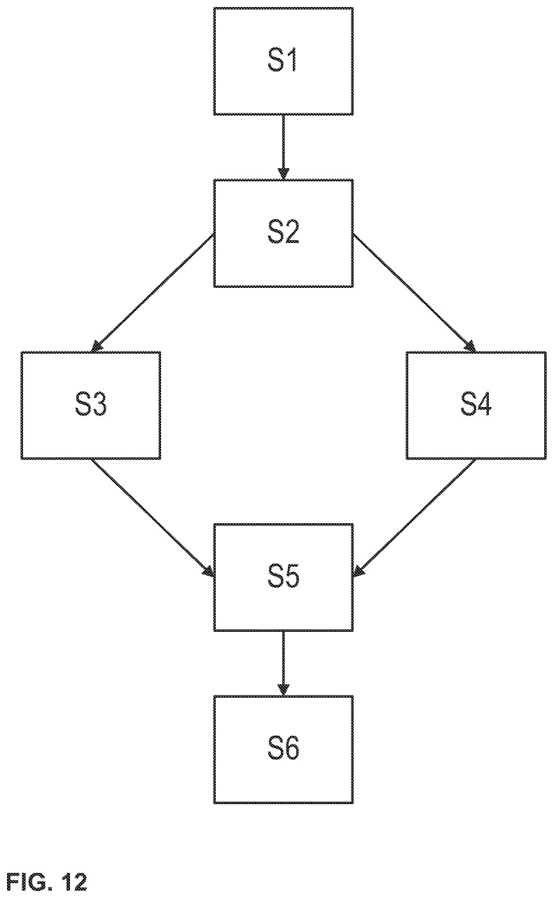

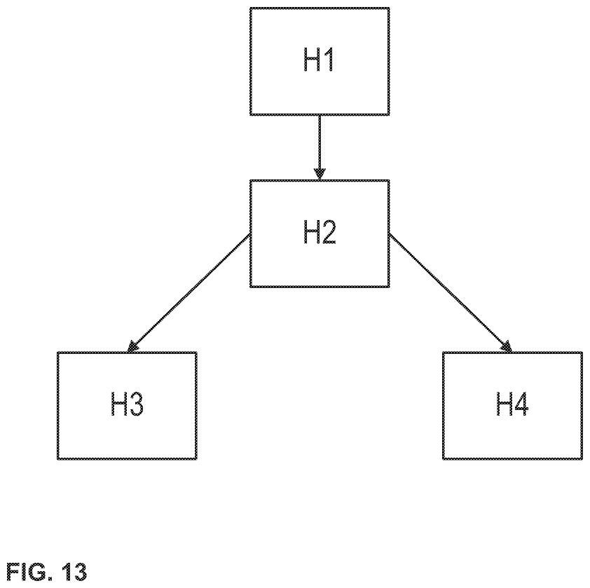

The shaft 32 of the fastening sleeve 30 has a continuous opening 36 which is capable of receiving a fastening means 90, which may be a threaded bolt (see FIGS. 10 and 11).

The threaded bolt 90 may rest against a bolt head directly or via a washer disc 80 at the radial collar 34 of the fastening sleeve 30. A threaded end 94 of a bolt shaft 92 engages into a nut thread element 96 in order to fasten the adjustment element 1 and thus the add-on part A to the structural component S. For this purpose, at a fastening opening O of the structural component, a blind rivet nut or a welding nut or a lose nut or an inner thread in the opening O may be provided as a nut thread element 96.

According to a first embodiment of the fastening sleeve 30, the shaft 32 may extend beyond the second axial end 18 of the hollow screw 10, when the radial collar 34 rests on the first axial end 12 of the hollow screw 10. This design is for example shown in FIG. 10.

Due to the axial length of the shaft 32, the fastening sleeve 30 may be screwed/connected on block with the structural component S via the threaded bolt 90. Despite the block connection, the hollow screw 10 is not clamped between structural component S and head of the threaded bolt 90 and therefore, it remains rotatable regarding its arrangement. This kind of fastening of the adjustment element 1 maintains the rotatability of the hollow screw 10 and thus an axial adjustability of the add-on part A which is held on the hollow screw 10 by means of the outer thread 14.

According to the embodiment of FIG. 11, the fastening sleeve 30 may end together with the second axial end 18 of the hollow screw 10 when the radial collar 34 rests on the first axial end 16 of the hollow screw 10. Once the adjustment element 1 with add-on part A has been fastened to the structural component with the help of the fastening means 90, the hollow screw 10 and the fastening sleeve 30 are clamped against the structural component S. By doing so, the hollow screw 10 is arranged firmly and non-rotatably on the structural component S.

This configuration of the adjustment element 1 requires that firstly, the add-on part A may be adjusted in terms of its axial position on the hollow screw 10. After completing the positioning of add-on part A and hollow screw 10 relative to one another, the hollow screw 10 is rigidly fastened via the fastening sleeve 30 and the fastening means 90, which may be a threaded bolt, to the structural component S. In this case, the distance Z between the hollow screw 10 and the structural components S is zero.

According to a further configuration, the hollow screw 10 and the fastening sleeve 30 may be made of a stable plastic material, such as polyamide (PA), polycarbonate (PC), polypropylene (PPH) with or without glass fiber reinforcement (GF). The hollow screw 10 and the fastening sleeve 30 may be made of the same plastic material.

According to a further embodiment, the fastening sleeve 30 may be made of metal. By that, a block connection with the structural component S may be supported, as plastic material tends to flow under mechanical load.

The fastening sleeve 30 is configured to be dampening, which may be vibration dampening. Dampening means that the fastening sleeve 30 is at least partially coated with an elastically and/or plastically deformable material on a radial 38 and/or axial outside 35. The axial outside 35 is formed by the side of the radial collar 34 which faces the shaft 32. The radial outside 38 is the outside of the shaft 36.

According to the embodiment of the vibration dampening fastening sleeve 30 according to FIG. 2, same is equipped with a dampening layer 40 on its radial outside 38 of the shaft 32 on at least partial surfaces or on the complete surface.

If the dampening layer 40, according to a further embodiment, is configured as two adjacent partial surfaces (see FIG. 2), a guiding groove 50 may be formed between the adjacent partial surfaces of the dampening layer 40. This guiding groove 50 may be suitable for receiving a suitable guiding web 52 of the hollow screw 10. By means of a suitable arrangement of guiding web 52 and guiding groove 50, a relative rotation between the hollow screw 10 and the fastening sleeve 30 can be avoided. Furthermore, the hollow screw 10 and the fastening sleeve 30 may be connected and held in a determined alignment with respect to each other, which may support an oriented arranging of the add-on part A to the structural component S.

A radial thickness of the dampening layer 40 is dimensioned such that a gap between the radial outside 38 of the shaft 32 and the inner completely circumferential limiting wall 22 of the hollow screw 10 is closed by the dampening layer 40. Accordingly, the elastically and/or plastically deformable dampening layer 40 may be held in a press-fit between the circumferential limiting wall 22 and the radial outside 38 of the shaft 32.

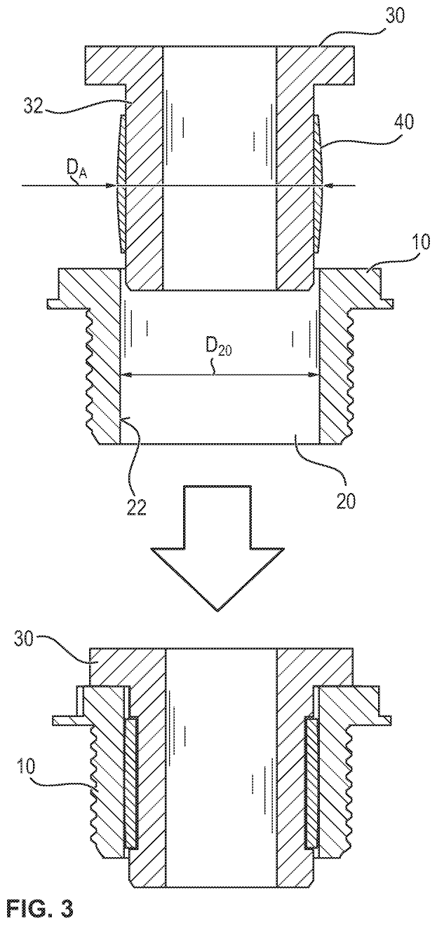

As an example, FIG. 3 shows the inserting of the dampening fastening sleeve 30 according to FIG. 2 into the tube-like fastening opening 20 of the hollow screw 10. An outer diameter D_{A} of the shaft 32 with vibration dampening layer 40 may be larger than an inner diameter D₂₀ of the tube-like fastening opening 20. Thus, the dampening layer 40 is compressed in radial direction after the inserting of the dampening fastening layer 30 into the tube-like fastening opening 20 of the hollow screw 10. By means of the coupling of the limiting wall 22 of the hollow screw 10 with the shaft 32 through the dampening layer 40, a vibration transmission, may push or stroke between add-on part A and structural component B may be decreased or dampened and may be prevented.

If the structural component S is for example subject to vibrations S_{R} in radial direction, same are transmitted on the fastening sleeve 30. The circumferential limiting wall 22 of the hollow screw 10 rests against the shaft 32 radially through the dampening layer 40. By that, the radial vibrations S_{R} are dampened or reduced and in the best case, they are not transmitted on the hollow screw 10 and the add-on part A connected with same.

According to a further embodiment, a dampening layer 42 is also provided on the underside of the radial collar 34 which faces the shaft 32, i.e. on its axial outer side 35. The dampening layer 42 may extend partially or completely across the axial outside 35 of the radial collar 34.

If for example the structural component S and/or the add-on part A is/are subject to vibrations S_{A} in axial direction, those vibrations are reduced or dampened or in the best case not transmitted at all on the adjacent component hollow screw 10 or fastening sleeve 30.

According to a further embodiment, a closed dampening layer 40, 42 may extend over the radial outside 38 of the shaft 32 and the axial outside 35 at the radial collar 34. Thus, the dampening layer 40, 42 may merge or may be formed as one dampening layer.

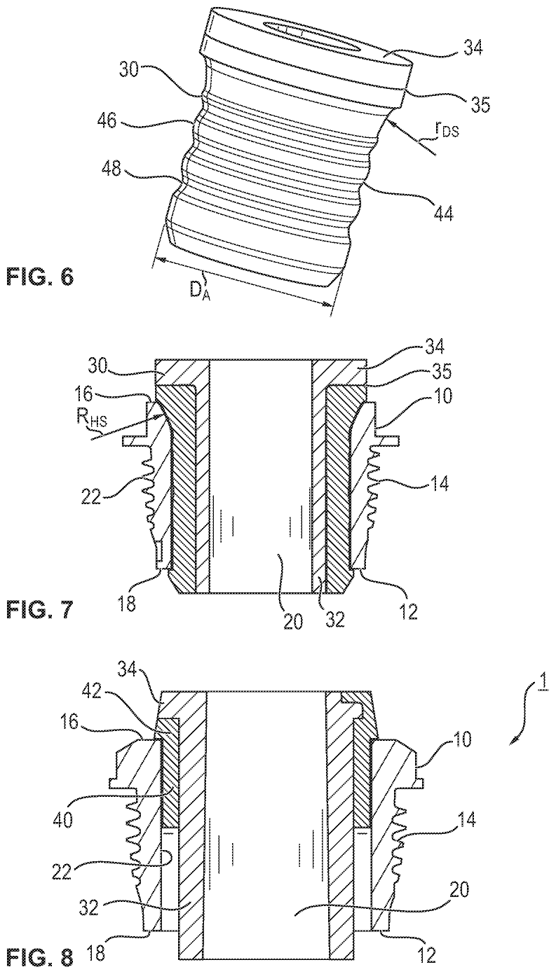

A further embodiment of the dampening fastening sleeve 30 is shown in FIG. 6. Starting at the shaft-facing side of the radial collar 34, the complete shaft 32 is coated with a continuous dampening layer 44. In an axial cross-section along the longitudinal axis L of the fastening sleeve 30, the continuous dampening layer 44 may extend in a wave-like manner. The fastening sleeve 30 and the hollow screw 10 and thus the structural component S and the add-on part A may rest against each other by means of the radial wavy hills 46 in a vibration dampening manner against one another. While the wavy hills 46 may receive the mechanical loads and may be deformed, the wavy troughs 48 serve for receiving suppressed material of the continuous dampening layer 44.

The dampening layer 44 may merge from the radial outside 38 of the shaft 32 into the axial outside 35 of the radial collar 34 in form of a radius r_{DS}. Here, the inner circumferential limiting wall 22 of the hollow screw 10 is formed with a corresponding complementary radius R_{Hs} in the direction of the first axial end 16. By that, a kind of a receiving hopper for the dampening fastening sleeve 30 to be received is formed. This configuration allows keeping the radial extension of the radial collar 34 low with small space requirement. Nonetheless, a high axial force from the fastening sleeve 30 into and onto the hollow screw 10 can be transmitted with this configuration. Despite the improved transfers of force or load, induced tensions between sleeve 30 and hollow screw 10 are only increased to the extent that the lifetime of the adjustment element 1 is not impaired.

The dampening layer 40, 42, 44 may be made of an elastic material. Accordingly, elastomers or thermoplastic elastomers (PPE) or styrene ethylene butylene styrene (SEBS) or similar materials are suitable.

In order to fasten and position the add-on part A, which may be a handle construction, a mirror or a vehicle light, to a structural component S, which may be a vehicle body, the following steps are carried out with reference to the above-described constructive configurations. Firstly, the fastening opening O may be provided in the structural component S with a thread, which may be by means of a welding nut or a blind rivet nut (S1). The thread is configured so that it matches the threaded bolt 90 as the fastening means.

In a further step, the hollow screw 10 of the adjustment element 1 is screwed into a supporting opening of the add-on part A (S2). By means of the screwing-in, the add-on part A is pre-positioned on the adjustment element. For this pre-positioning, it may be necessary to rotate the hollow screw 10 (S5) so that the add-on part A is displaced along the longitudinal axis L of the hollow screw 10. This rotating can take place before or after fastening the adjustment element 1 at the structural component S.

With the help of the fastening means 90, which may be a threaded bolt, the hollow screw 10 is fastened with the add-on part A at the opening O of the structural component S (S4). For this purpose, the fastening means 90 is arranged within the tube-like fastening opening 36 of the dampening fastening sleeve 30.

In order to arrange the hollow screw 10 rotatably at the structural component S, the threaded bolt 90 may be arranged in combination with a supporting disc 80 in the dampening fastening sleeve 30 (S3). If the fastening sleeve 30 extends axially beyond the hollow screw 10, the hollow screw 10 is rotatably fastened at the structural component S. If the fastening sleeve 30 ends with the hollow screw 10, the axial position of the add-on part A on the hollow screw 10 takes place before the fastening to the structural component S. For setting the axial position of the add-on part A on the hollow screw 10, the hollow screw 10 is rotated by means of an outer or an inner drive feature (S6).

Furthermore, the present disclosure also includes an injection molding method with which the adjustment element 1 can be produced. It contains the following steps: providing an injection mold with the complementary form features with regard to the adjustment element 1, injection molding the hollow screw 10 and the fastening sleeve 30 with a first plastic material in a first injection and injection-molding an elastic dampening layer on an outer surface of the fastening sleeve 30 with a second plastic material in a second injection, with the second plastic material having a higher elasticity than the first plastic material. The injection molding of the elastic dampening layer may be carried out on an outer lateral surface of the fastening sleeve 30 or on the outer lateral surface and a side facing the lateral surface of the radial collar of the fastening sleeve 30.

1. An adjustment element with which a component is fastenable and positionable in the space, comprising the following features:
a. a sleeve-like hollow screw with a first and a second axial end, a drive feature and an outer thread at which a component is supportable and positionable in axial direction of the hollow screw,
b. a tube-like fastening opening extends between the first and the second axial end of the sleeve-like hollow screw,
c. within the tube-like fastening opening, a dampening fastening sleeve is arranged so that the hollow screw is fastenable by means of the fastening sleeve with a fastening means to a structural component and vibrations between the structural component and the hollow screw is reducible.

2. The adjustment element according to claim 1, the dampening fastening sleeve of which has a circumferential and outwardly protruding radial collar on a first axial end, with the radial collar projecting beyond an inner diameter of the tube-like fastening opening, so that the fastening sleeve is axially supportable on the first or the second axial end of the hollow screw.

3. The adjustment element according to claim 1, whose dampening fastening sleeve, measured without radial collar, is configured longer than the tube-like fastening opening, so that the hollow screw is rotatably fastenable to a structural component at the fastening sleeve.

4. The adjustment element according to claim 1, whose dampening fastening sleeve comprises a first elastic dampening layer on a radially outer lateral surface so as to reduce a vibration transmission between the hollow screw and the fastening sleeve.

5. The adjustment element according to claim 4 where an inner diameter of the tube-like fastening opening is smaller than an outer diameter of the dampening fastening sleeve with elastic dampening layer, so that the fastening sleeve is held in the tube-like fastening opening in a friction-fit manner.

6. The adjustment element according to claim 4, the dampening fastening sleeve of which has a circumferential and outwardly protruding radial collar on a first axial end, with the radial collar projecting beyond an inner diameter of the tube-like fastening opening, so that the fastening sleeve is axially supportable on the first or the second axial end of the hollow screw, and whose radial collar comprises a second elastic dampening layer on a side facing the shaft of the fastening sleeve so as to reduce a vibration transmission in axial direction between the hollow screw and the fastening sleeve.

7. The adjustment element according to claim 1, which is fastenable by means of the fastening means to a structural component, the outer diameter of which is smaller than an inner diameter of the fastening opening so as to guarantee a radial tolerance compensation between the adjustment element and the fastening means.

8. A structural component with an opening to which the adjustment element according to claim 1 is fastened with a fastening means.

9. The structural component according to claim 8, wherein a component is fastened on the outer thread of the hollow screw of the adjustment element in a way that tolerances between the structural component and the component are adjustable.

10. An installation method, with which an add-on part is fastenable and positionable to a structural component, wherein the installation method comprises the following steps:
a. screwing-in a hollow screw of the adjustment element according to claim 1 into a supporting opening of the add-on part,
b. rotating the hollow screw which is fastened to the structural component such that the add-on part is displaced along a longitudinal axis of the hollow screw and
c. fastening the hollow screw with add-on part to an opening of the structural component with a fastening means which is arranged within the tube-like fastening opening of the dampening fastening sleeve.

11. The installation method according to claim 10, with the further step:
providing the opening of the structural component with a thread which is configured so as to match a threaded bolt as the fastening means.

12. The installation method according to claim 11 with the further step:
arranging the threaded bolt in combination with a supporting disc in the dampening fastening sleeve, so that the hollow screw is fastened in a rotatable manner to the structural component.

13. The installation method according to claim 11, with the further step:
rotating the hollow screw by means of an outer or an inner drive feature so as to change the axial position of the add-on part on the hollow screw.

14. An injection molding method with which an adjustment element according to claim 1 can be produced, the method comprising the following steps:
a. providing an injection mold with the complementary form features with respect to the adjustment element,
b. injection molding the hollow screw and the fastening sleeve with a first plastic material in a first injection and
c. injection molding an elastic dampening layer on an outer surface of the fastening sleeve with a second plastic material in a second injection, with the second plastic material having a higher elasticity than the first plastic material.

15. The injection molding method according to claim 14 with the further configuration:
injection molding the elastic dampening layer on an outer lateral surface of the fastening sleeve or on the outer lateral surface and a side of the radial collar of the fastening sleeve which faces the lateral surface.
